(19) United States
(12) Patent Application Publication
(10) Pub. No.: US 2026/0118538 A1
(43) Pub. Date: Apr. 30, 2026

(54) METHODS AND SYSTEM FOR DETERMINING FORMATION PORE PRESSURES

(71) Applicant: CHINA PETROLEUM & CHEMICAL CORPORATION, Beijing (CN)

(72) Inventors: Zhihui FAN, Houston, TX (US); Jon Jincai ZHANG, Houston, TX (US); Peiqing LIAN, Houston, TX (US)

(21) Appl. No.: 18/930,872

(22) Filed: Oct. 29, 2024

(51) Int. Cl. G01V 1/30

(52) U.S. Cl. CPC G01V 1/306; G01V 2210/1295; G01V 2210/1425; G01V 2210/6169; G01V 2210/6248

(57) ABSTRACT

A method for estimating formation pore pressure in a subsurface formation includes the steps of processing, by a computer system, seismic and well log data to determine formation parameters selected from a formation type, a formation bulk density, a formation porosity, a formation water density, a depth, a transit time, and a gravity; calculating a vertical stress by integrating the formation bulk density in a vertical direction of the formation; calculating a hydrostatic pore pressure based on the formation water density, the depth, and the gravity; calculating a normal porosity or normal transit time based on an initial porosity or initial transit time, a formation compact constant, and the depth; and calculating a calculated pore pressure; and obtaining a difference between the calculated pore pressure with a measured pore pressure; minimizing the difference using an iterative process by adjusting the formation compaction constant.

### TECHNICAL FIELD

The disclosure generally relates to method and device for subsurface engineering. In particular, this disclosure provides systems and methods for predicting pore pressures in subsurface formations.

### BACKGROUND OF INVENTION

Pore pressures in subsurface formations are crucial parameters in most subsurface engineering. Abnormal pore pressures present great challenges for drilling in geo-energy industries and for CO₂ storage. Abrupt changes in formation pore pressure may cause serious drilling incidents when not compensated properly, e.g., fluid influxes into wellbore, well blowouts, etc. In this regard, when a fully fluid-saturated subsurface formation is normally compacted, particularly in a shallow depth, the pore pressure in the formation is a hydrostatic pore pressure, i.e., normal pore pressure. In this case, the porosity in the formation gradually decreases as depth increases. However, if porosity in a formation decreases less rapidly or even becomes reversal with depth, particularly in the deep formations, the formation experiences under-compaction, which causes abnormally high pore pressure. Conventional methods for pore pressure prediction are mainly based on empirical equations, such as Eaton's method (Eaton, 1975) or Bowers' method (Bowers, 1995). These conventional methods require several empirical parameters that are difficult to obtain, thus affecting the accuracy of the pore pressure prediction. Accordingly, there is a great need for methods that can accurately and easily predict pore pressure in the subsurface formation.

The current disclosure provides new systems and methods for more accurate predictions of subsurface pore pressures, as illustrated in more details below.

### SUMMARY OF THE INVENTION

According to one embodiment in the current disclosure, a method for estimating formation pore pressure in a subsurface formation includes the following steps: S1, deploying a plurality of data recording sensors in a survey region and/or in a well logging tool into a wellbore in the survey region; S2, collecting seismic data and well log data using the plurality of data recording sensors; S3, storing the seismic data and well log data in one or more memories in a computer system; S4, processing, by the computer system, the seismic and well log data to determine formation parameters selected from a formation type, a formation bulk density, a formation porosity, a formation water density, a depth, a transit time, and a gravity; S5, calculating, by the computer system, a vertical stress by integrating the formation bulk density in a vertical direction of the formation; S6, calculating, by the computer system, a hydrostatic pore pressure based on the formation water density, the depth, and the gravity; S7, calculating, by the computer system, a normal porosity or normal transit time based on an initial porosity or initial transit time, a formation compact constant, and the depth; S8, calculating, by the computer system, a calculated pore pressure; and S9, obtaining a difference between the calculated pore pressure with a measured pore pressure, when the difference is larger than a threshold value, adjusting the formation compaction constant to a different value, inputting the adjusted formation compaction constant into S7 and repeating S7, S8, and S9, and when the difference is not larger than the threshold value, outputting the calculated pore pressure as the formation pore pressure.

According to another embodiment of the current disclosure, a system for determining formation pore pressure in a subsurface formation of a survey region includes a plurality of seismic data recording sensors positioned in the survey region at different locations and/or a well logging tool including seismic data recording sensors positioned in a well bore in the survey region; a blasting device positioned at each point of incidence in the survey region to generate seismic waves, which travel through subsurface earth formations; wherein the data recording sensors transmit seismic data and well log data to a computer system including one or more memories and at least one processor, the one or memories store the transmitted seismic data, the transmitted well log data, and instructions. The one or more processors in the computer system execute the instructions stored in the one or more memories to implement the following steps: processing the seismic data and/or well log data to determine formation parameters selected from a formation type, a formation bulk density, a formation porosity, a formation water density, a depth, a transit time, and a gravity; calculating a vertical stress by integrating the formation bulk density in a vertical direction of the formation; calculating a hydrostatic pore pressure based on the formation water density, the depth, and the gravity; calculating a normal porosity based on an initial porosity or a normal transit time based on an initial transit time, a formation compaction constant, and the depth; calculated pore pressure; and obtaining a difference between the calculated pore pressure with a measured pore pressure, when the difference is larger than a threshold value, assigned a different value to formation compaction constant.

### BRIEF DESCRIPTION OF THE DRAWINGS

The present invention can be readily understood by considering the following detailed description of the drawings.

FIG. 1 is a schematic diagram illustrating a top view of a survey region with the various points of incidence of seismic sources according to an embodiment in this disclosure.

FIG. 2 is a schematic diagram illustrating a cross-sectional view of an environment with points of incidence of seismic sources, seismic data recording sensors, a well location, a wellbore, the various transmission rays, and the various angles of incidence, according to an embodiment in this disclosure.

FIG. 3 is a schematic diagram illustrating a cross-sectional view of an environment with a wellbore and a well logging tool including one or more sonic generators and one or more well log data recording sensors according to an embodiment in this disclosure.

FIG. 4 is a schematic diagram illustrating a high-performance computing system according to an embodiment in this disclosure.

FIGS. 5A and 5B are schematic diagrams illustrating changes in porosity and in pore pressure, respectively, along the vertical direction in the subsurface formation.

FIG. 6 is a flow chart according to a first embodiment for predicting the pore pressure in the current disclosure.

FIGS. 7A and 7B present data regarding the porosity and the pore pressure, respectively, in the subsurface formation according to the first embodiment of the current disclosure.

FIGS. 8A and 8B are schematic diagrams illustrating changes in transit time and in pore pressure, respectively, along the vertical direction in the subsurface formation.

FIG. 9 is a flow chart according to a second embodiment for predicting the pore pressure in the current disclosure.

FIGS. 10A and 10B present intermediate results in calculating transit time and the pore pressure, respectively, in the subsurface formation according to the second embodiment of the current disclosure.

FIGS. 11A and 11B, in comparison with FIGS. 10A and 10B, present final results of the transit time and the pore pressure, respectively, in the subsurface formation according to the second embodiment of the current disclosure.

FIG. 12 compares the pore pressure data according to a conventional method with the pore pressure data shown in FIG. 11B.

### DETAILED DESCRIPTION OF THE INVENTION

Reference will now be made in detail to several embodiments of the present disclosures, examples of which are illustrated in the accompanying figures. It is noted that wherever practicable similar or like reference numbers may be used in the figures and may indicate similar or like functionality. The figures depict embodiments of the present disclosure for purposes of illustration only. One skilled in the art will readily recognize from the following description that alternative embodiments of the structures, systems, and methods illustrated herein may be employed without departing from the principles of the disclosure described herein.

The present disclosure relates to methods for predicting subsurface pore pressure in the vertical direction, which ensures a well-managed drilling operation.

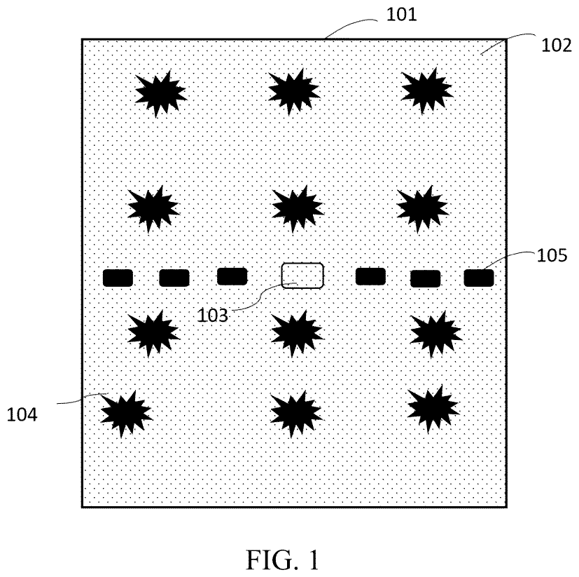

FIGS. 1-4 show exemplary embodiments of methods, apparatuses, and mediums for obtaining and storing the seismic and well logging data, which is processed to generate the one or more high resolution geological models for high resolution images for lithology identification, fluid discrimination, and reservoir characterization of complex subsurface structures of a survey region. The survey region may be subsurface structures under land or subsurface structures under the sea. In this disclosure seismic data refers generally to data collected using seismic techniques, e.g., seismic or acoustic methods. Well logging data refers to data obtained in well bores using logging tools, including acoustic, electromagnetic, neutron, NMR signals. Used herein seismic data and well logging data are collectively referred to as measured data.

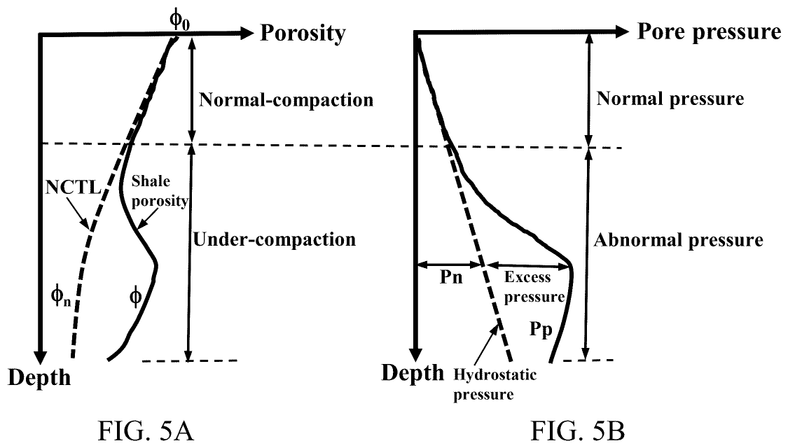

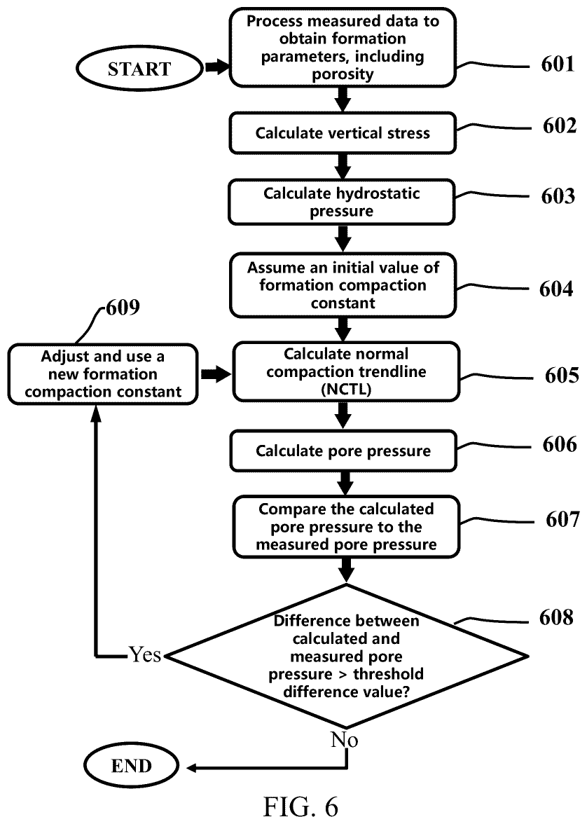

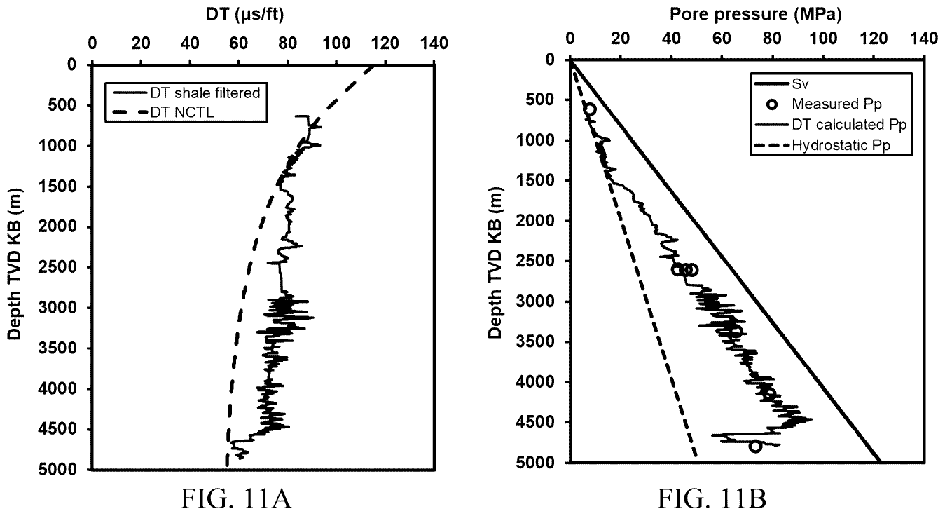

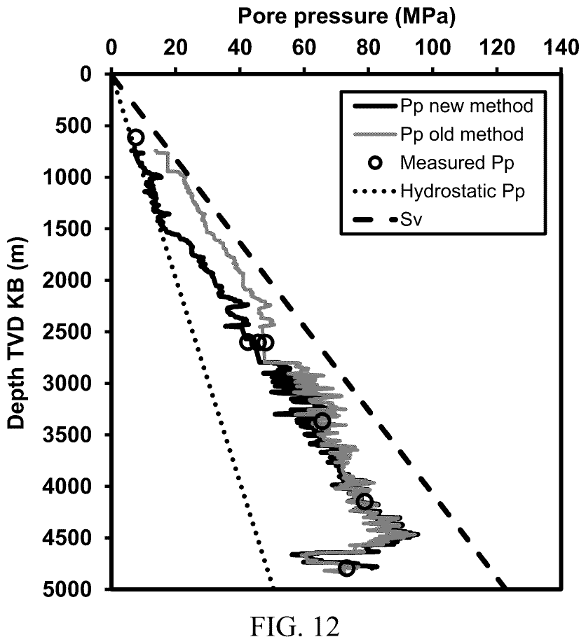

FIG. 5 illustrates the methods of the current invention based on seismic data or well logging data. FIGS. 6-11 present data obtained using the methods in this invention. Finally, FIG. 12 compares data according to a conventional method with data shown in FIG. 11B.

FIG. 1 is a schematic diagram illustrating a top view of a survey region with the various points of incidence of seismic sources according to an embodiment. More specifically, FIG. 1 illustrates a seismic survey region (survey region) 101, which is a land-based region denoted by reference numeral 102. Reference number 102 denotes the top earth formation of the land-based region 102. Persons of ordinary skill in the art, will recognize that seismic survey regions produce detailed images of local geology to determine the location and size of possible hydrocarbon (oil and gas) reservoirs, and therefore a well location 103. In these survey regions, seismic waves bounce off underground rock formations during emissions from one or more seismic sources at various points of incidence 104. A blast is an example of a seismic source generated by seismic equipment. The seismic waves that reflect back to the surface are captured by seismic data recording sensors 105, transmitted by one or more data transmission systems (frequently wirelessly) from the seismic data recording sensors 105, and stored for later processing and analysis by a high-performance computing system. Although this example shows a top earth formation of a land-based region 102, it is understood that this is only an example, and the methods and system may also be applied to a survey region at the bottom of an ocean.

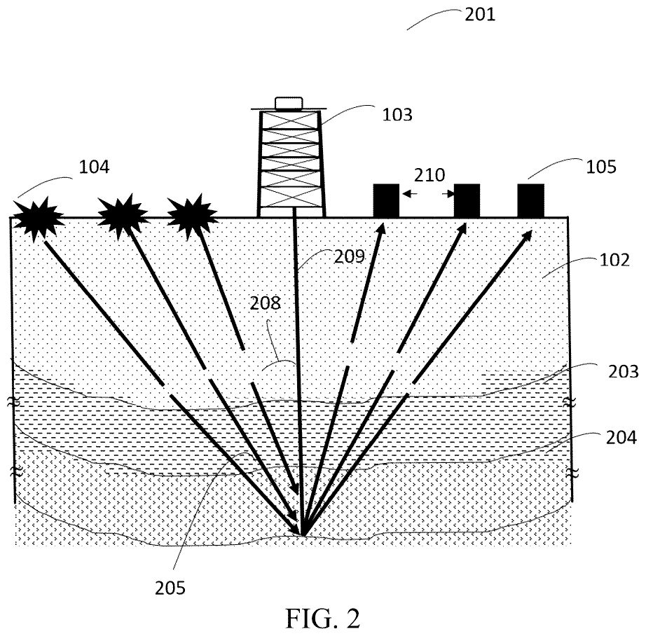

FIG. 2 is a schematic diagram illustrating a cross-sectional view of a seismic survey region 101 in FIG. 1 with points of incidence of seismic sources, seismic data recording sensors (seismic receivers), a well location, a wellbore, the various transmission rays, and the various angles of incidence, according to an embodiment. More specifically, in FIG. 2 a cross-sectional view of a portion of the earth over the seismic survey region denoted by reference numeral 201, showing different types of earth formations denoted by reference numerals 102, 203, and 204. Although the seismic survey region is based on land in this example, it is understood that the methods and system may also be applied to a survey region at the bottom of an ocean. FIG. 2 illustrates a common midpoint-style gather, where seismic data are sorted by surface geometry to approximate a single reflection point in the earth. The survey seismic data may also be referred to as traces, gathers, or image gathers. In this example in FIG. 2, data from one or more shots or blasts and receivers may be combined into a single image gather or used individually depending upon the type of analysis to be performed.

As shown on FIG. 2, one or more shots or blasts represent seismic sources located at various points of incidence or stations denoted by reference numeral 104 at the surface of the Earth at which one or more seismic sources are activated. Seismic energy or seismic sources from multiple points of incidence 104, are reflected from the interface between the different earth formations. These reflections are captured by multiple seismic data recording sensors 105, each of which is placed at different location offsets 210 from each other, and the well 103. Because all points of incidences 104, and all seismic data recording sensors 105 are placed at different offsets 210, the survey seismic data or traces, also known in the art as gathers or image gathers, is recorded at various angles of incidence represented by 208. The points of incidence 104 generate downward transmission rays 205, in the earth that are captured by their upward transmission reflection through the seismic data recording sensors 105. Well location 103, in this example, is illustrated with an existing drilled well attached to a wellbore, 209, along which multiple measurements are obtained using techniques known in the art. This wellbore 209, is used to obtain well log data, which may include P-wave velocity, S-wave velocity, density, resistivity, among others. Other sensors, not depicted in FIG. 2, may be placed within the survey region to capture seismic data. Seismic data may be used to examine the dependence of amplitude, signal-to-noise, move-out, frequency content, phase, and other seismic attributes, on incidence angles 208, offset measurements 210, azimuth, and other geometric attributes that are important for data processing and imaging of a seismic survey region.

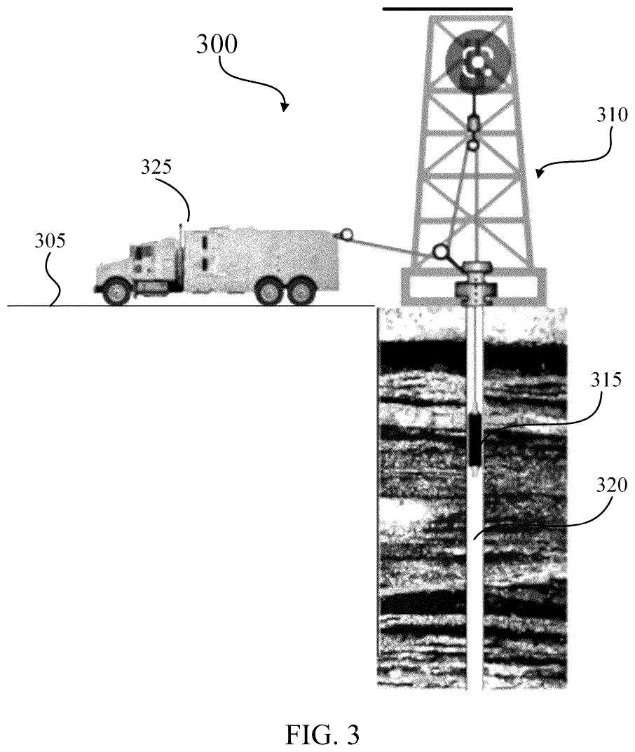

FIG. 3 is a schematic diagram illustrating a cross-sectional view of a seismic survey region with a wellbore and well logging tool including one or more sonic generator and one or more well log data recording sensors according to an embodiment. A sonic generator is an example of equipment that produces one or more sonic waves (sound waves). A sonic generator may be referred to as a sonic source because the sonic generator produces or generates one or more acoustic waves. One or more well log data recording sensors are examples of one or more data recording sensors (seismic receivers or data recorders) and may be the same data recording sensors as data recording sensors 105. In embodiments of the present invention, oil and/or gas production is discontinued in order to generate seismic waves and record seismic data including reflections of the seismic waves moving through the subsurface of one or more earth formations in the seismic survey region.

FIG. 3 shows an oil drilling system 300 on land 305 that includes a drilling rig 310. The drilling rig 310 supports the lowering of a well logging tool 315 into a wellbore 320. The well logging tool 315 may include one or more sonic generators (sonic sources) to generate one or more sound waves, which are transmitted into one or more earth formations to generate reflections and refractions in the one or more earth formations. Although this example shows one or more earth formations of a land-based survey region, it is understood that this is only an example and that the methods and systems may also be applied to a survey region at the surface or bottom of a body of water such as an ocean. The well logging tool 315 also includes one or more well log data recording sensors. As discussed above, the one or more well log data recording sensors receive and record well log data, which includes the data received by the one or more well log data recording sensors in response to the sound waves transmitted into one or more earth formations by the one or more sonic generators. The well log data may include compressional wave velocity or P-wave velocity (Vp), shear wave velocity (Vs), and density, which is an indicator of porosity. This well logging process to record well log data may also be referred to as acoustic well logging. A vehicle 325 may be coupled to the well logging tool 315 to assist in the lowering and raising of the well logging tool 315 as well as communicating with the well logging tool 315 to obtain well log data. Alternatively, in methods and systems for a survey region at the surface or bottom of a body of water such as an ocean, another device or system may use to assist in the lowering or raising of the well logging tool 315 as well as communicating with the well logging tool 315 to obtain well log data.

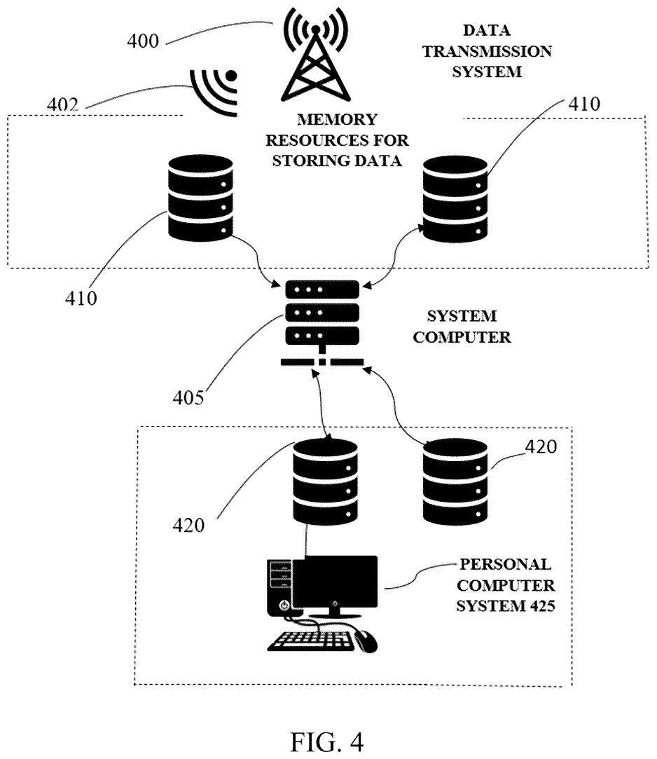

FIG. 4 is a schematic diagram illustrating a high-performance computer system according to an embodiment, which receives (through cable or wirelessly) seismic data regarding seismic waves from the seismic data recording sensors 105 in FIGS. 1 and 2 and/or the well log data recording sensors in FIG. 3, which are also referred to as well log data recording sensors in FIG. 3. The high-performance computer system in FIG. 4 stores the measured data in at least one memory for later processing and analysis by computer implemented methods and apparatuses of one or more embodiments. The analyzed or processed data may be accessed by a personal computer system. More specifically, FIG. 4 shows a data transmission system 400 for wirelessly transmitting data from data recording sensors to a system computer 405 coupled to one or more storage devices 410 to store the measured data in databases. The data transmission system may also transmit wirelessly measured data from data recording sensors 405 directly to one or more storage devices 410 to store the measured data in databases, which may be accessed by system computer 405. The wireless transmission is denoted by reference numeral 402. The one or more storage devices 410 may also store other computer software instructions or programs to implement apparatuses and methods described in embodiments. The system computer 405 may be coupled (e.g., wirelessly coupled) to one or more output storage devices 420, which may receive the results of computer implemented processes or methods performed by the system computer 405. A personal computer 425 may be coupled (e.g., wirelessly coupled) to one or more output storage devices 420 and/or to the computer system 305 so that a user may utilize a user interface of the personal computer 425 to input information or obtain the results of the computer implemented processor methods performed by the system computer 405. The one or more storage devices 420 may also store other computer software instructions or programs to implement apparatuses and methods described in embodiments.

A user interface of the personal computer 425 may include, for example, one or more of a keyboard, a mouse, a joystick, a button, a switch, an electronic pen or stylus, a gesture recognition sensor (e.g., to recognize gestures of a user including movements of a body part), an input seismic device or voice recognition sensor (e.g., a microphone to receive a voice command), an output seismic device (e.g., a speaker), a track ball, a remote controller, a portable (e.g., a cellular or smart) phone, a tablet PC, a pedal or footswitch, a virtual-reality device, and so on. The user interface may further include a haptic device to provide haptic feedback to a user. The user interface may also include a touchscreen, for example. In addition, a personal computer 425 may be a desktop, a laptop, a tablet, a mobile phone or any other personal computing system.

Processes, functions, methods, and/or computer software instructions or programs in apparatuses and methods described in embodiments herein may be recorded, stored, or fixed in one or more non-transitory computer-readable media (computer readable storage (recording) media) that includes program instructions (computer readable instructions) to be implemented by a computer to cause one or more processors to execute (perform or implement) the program instructions. The media may also include, alone or in combination with the program instructions, data files, data structures, and the like. The media and program instructions may be those specially designed and constructed, or they may be of the kind well-known and available to those having skill in the computer software arts. Examples of non-transitory computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions may be executed by one or more processors. The described hardware devices may be configured to act as one or more software modules that are recorded, stored, or fixed in one or more non-transitory computer-readable media, in order to perform the operations and methods described above, or vice versa. In addition, a non-transitory computer-readable medium may be distributed among computer systems connected through a network and program instructions may be stored and executed in a decentralized manner. In addition, the computer-readable media may also be embodied in at least one application specific integrated circuit (ASIC) or Field Programmable Gate Array (FPGA).

The one or more databases may include a collection of data and supporting data structures which may be stored, for example, in the one or more storage devices 410 and 420. For example, the one or more storage devices 410 and 420 may be embodied in one or more non-transitory computer readable storage media, such as a nonvolatile memory device, such as a Read Only Memory (ROM), Programmable Read Only Memory (PROM), Erasable Programmable Read Only Memory (EPROM), and flash memory, a USB drive, a volatile memory device such as a Random Access Memory (RAM), a hard disk, floppy disks, a blue-ray disk, optical media such as CD ROM discs and DVDs, or cloud data storage devices, or combinations thereof. However, examples of the storage devices 410 and 420 are not limited to the above description, and the storage may be realized by other various devices and structures as would be understood by those skilled in the art.

FIG. 5A and FIG. 5B are schematic illustrations of the porosity and pore pressure of a subsurface formation in the vertical direction, respectively. The broken line in FIG. 5A represents the normal compaction trend line (NCTL) of porosity φₙ. That is, in a normal subsurface formation, the “NCTL” porosity φₙ continues to decrease as the depth increases due to compaction. The solid line in FIG. 5A indicates that the actual porosity φ deviates from φₙ. According to FIG. 5A, the actual porosity φ coincides with φₙ at a shallow depth, but decreases slower than that φₙ does as the depth increases and exhibits a reversal in porosity, i.e., the porosity increases as the depth increases. In FIG. 5B, the broken line represents the hydrostatic pore pressure pₙ, i.e., the normal pore pressure, which increases continuously along the depth direction. However, the actual pore pressure pₚ deviates from pₙ and exhibits a significant overpressure from the hydrostatic pore pressure pₙ, which may cause accidents during drilling.

FIG. 6 is a flowchart illustrating the first embodiment of the methods for determining pore pressure in subsurface formation. The survey region may be subsurface structures under land or subsurface structures under the sea.

This method is based on the measured formation porosity and the porosity based on the normal compaction trendline (NCTL) of the formation, i.e., the normal porosity. It can be mathematically expressed in Equation (1):

$${p}_{ϕ} = {p}_{n} + \frac{( {σ}_{V} - {p}_{n} )}{cD} ln ( \frac{ϕ}{{ϕ}_{n}} ) , \qquad ( 1 )$$

in which p_{φ} is the formation pore pressure, pₙ is the hydrostatic pore pressure, while the second term on the right side of the equation is the excess pressure or overpressure in the formation. Further, σ_{V} is the vertical stress, which can be calculated by integrating formation bulk density; c is the formation compaction constant; D is the depth; φ is the porosity of the subsurface formation, which can be derived from density, acoustic, or neutron logs; and φₙ is the normal porosity according to the compaction trend line (NCTL) of formation porosity, which is known in the art.

Equation (2) shows the calculation of the normal porosity:

$${ϕ}_{n} = {ϕ}_{0} {e}^{- cD} , \qquad ( 2 )$$

wherein φ₀ is the porosity in the mudline or at the ground surface. The value of φ₀ can be in the range of 0.5-0.8.

The hydrostatic pore pressure pₙ can be calculated from formation water density ρ_{w} according to Equation (3):

$${p}_{n} = {ρ}_{w} gD , \qquad ( 3 )$$

where g is the acceleration of gravity.

Referring to FIG. 6, the measured data is inputted at the start of the method of FIG. 6. The measured data can be a seismic velocity model (i.e., seismic velocity) obtained through seismic survey or well log data. The well log can be wireline well log or well log data while drilling (LWD). Such data is stored and/or processed on a computing device prior to the execution of the method of FIG. 6. For example, the seismic data recording sensors 105 in FIGS. 1 and 2 and/or the well log data recording sensors of the well logging tool 315 in FIG. 3 may detect the seismic data and transmit the seismic data to the high-performance computing system shown in FIG. 4. As discussed above in FIGS. 1-4, the seismic data detected in the survey region may be stored in one or more memories such as one or more storage devices 410 and one or more output storage devices 420.

In step 601, the measured data is processed to obtain formation parameters. E.g., the gamma ray log, which can be used to determine the formation type using known methods, as well as formation bulk density, water density, and porosity, etc. Transit time DT is also obtained based on seismic survey data or well log data. In step 602, vertical stress σ_{V} is calculated by integrating the bulk density of the formation. In step 603, the hydrostatic pore pressure can be calculated based on Equation (3) using the water density ρ_{w}, the depth D, and gravity g. In step 604, the formation compaction constant is assumed based on empirical data, e.g., based on data from the neighboring wells. In step 605, the normal porosity φₙ is calculated according to Equation (3). The initial porosity φ₀ is obtained by measuring the porosity of formation in the mudline or at the earth surface. In step 606, the pore pressure is calculated based on Equation (1). The calculated pore pressure is compared against the pore pressure measured during drilling in step 607. The difference between the calculated and measured pressures is compared with a preset threshold value in step 608. When the difference is larger than the threshold value, the formation compaction constant is adjusted in step 609 and used in recalculating the normal porosity φₙ is step 605. Such iterations are carried out until the difference becomes lower than the threshold value.

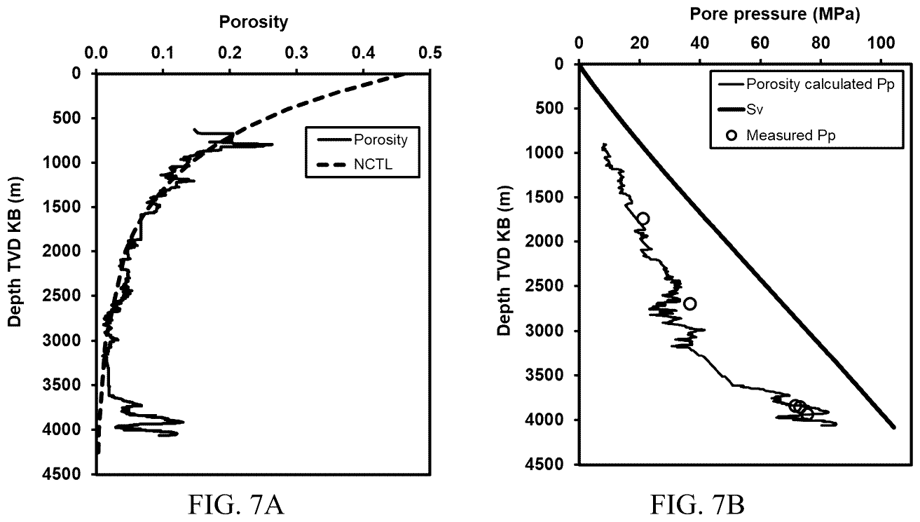

The method illustrated in FIG. 6 and Equations (1)-(3) were used to predict pore pressures in a tight gas play to determine pore pressure from porosity using this new equation. The results are shown in FIGS. 7A and 7B. FIG. 7A shows the predicted porosity φ matches well with the normal porosity φₙ to the depth about 3500 m. In FIG. 7B, the straight line represents vertical stress σ_{V} that increases linearly in the vertical direction; the jagged curve shows the calculated pore pressure p_{φ}; while the circles denotes the measured pore pressure pₚ. Most of measured pₚ data points fall on the p_{φ} curve.

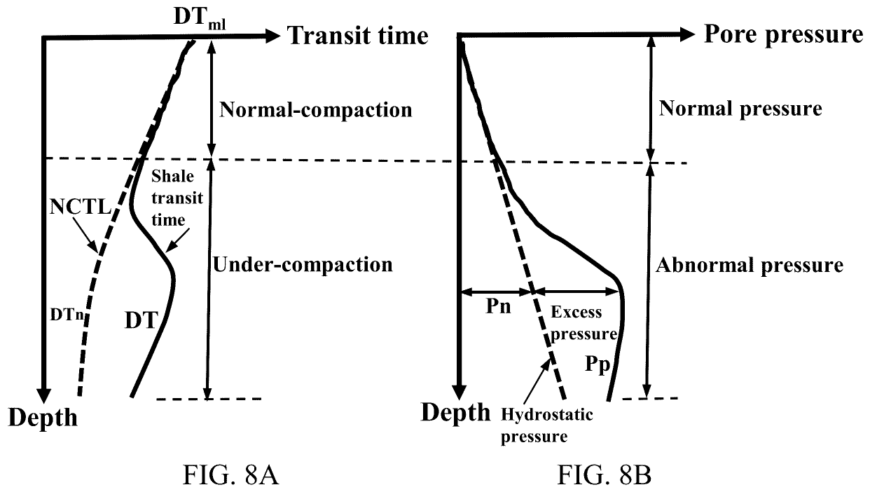

Pore pressure can also be predicted based on transit time. FIG. 8A and FIG. 8B are schematic illustrations of the porosity and pore pressure of a subsurface formation in the vertical direction, respectively. The broken line in FIG. 8A represents the normal compaction trend line (NCTL) of transit time DTₙ. In a subsurface formation with hydrostatic pore pressure, DTₙ continues to decrease as the depth increases under compaction. The solid line in FIG. 8A indicates that the scenario in which the actual transit time DT deviates from DTₙ. According to FIG. 8A, the actual transit time DT coincides with DTₙ at a shallow depth, but decreases slower than that in DT as the depth increases and later exhibits a reversal in transit time, i.e., the transit time increases as the depth increases. Referring to FIG. 8B, the broken line represents the hydrostatic pore pressure pₙ, which increases continuously along the depth direction. However, the actual pore pressure pₚ deviates from pₙ and exhibits a significant overpressure from the hydrostatic pore pressure pₙ.

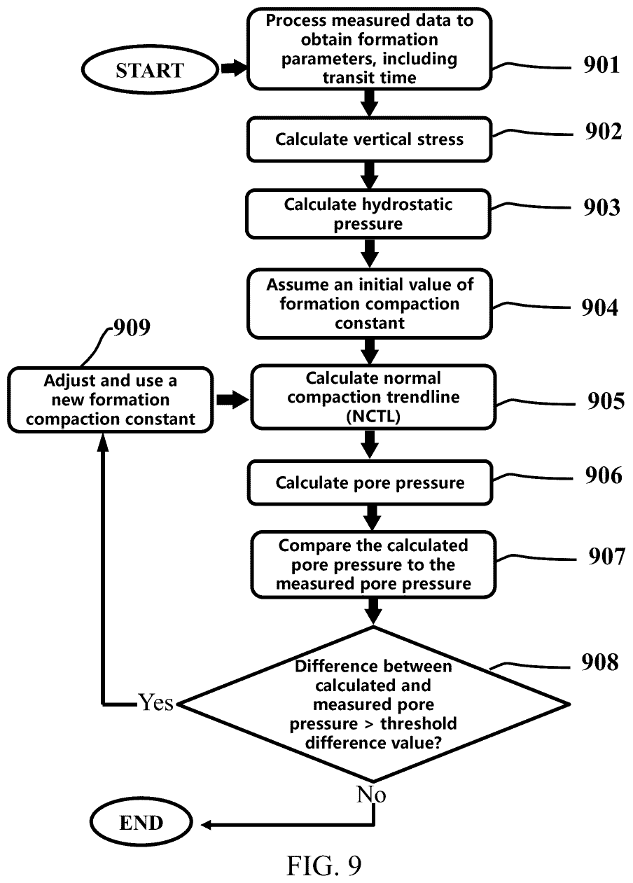

FIG. 9 illustrates the second embodiment in the methods to predict pore pressure in the current disclosure. Differing from the first embodiment depicted in FIG. 8, the second embodiment is based on transit time DT and does not rely on calculating the normal porosity φₙ. This method can be summarized mathematically in Equation (4)-(7).

Transit time in the formation can usually be obtained from seismic velocities or acoustic well logs. Equation (4) calculates pore pressure using the measured transit time DT and normal compaction trend line of transit time DTₙ. Similar to FIG. 1, the first term on the right side of Equation (4) is the hydrostatic pore pressure, while second term on the right side of the equation represents the excess pressure or overpressure in the formation.

$${p}_{s} = {p}_{n} + \frac{( {σ}_{V} - {p}_{n} )}{cD} [ ln ( DT - {DT}_{m} ) - ln ( {DT}_{n} - {DT}_{m} ) ] , \qquad ( 4 )$$

in which pₛ is the formation pore pressure calculated from acoustic well log data or seismic velocity data; DT is the measured acoustic or seismic transit time in the formation; DTₘ is the compressional transit time in the formation, normally DTₘ is about 65 μs/ft, i.e., 213 μs/m; and DTₙ is the normal transit time according to the compaction trend line (NCTL) of acoustic or seismic transit time.

DTₙ can be obtained according to Equation (5):

$${DT}_{n} = {DT}_{m} + ( {DT}_{m 1} - {DT}_{m} ) {e}^{- cD} , \qquad ( 5 )$$

in which DTₘₗ is the compressional transit time in the mudline or the ground surface.

Steps in this method are presented in FIG. 9. In step 901, the measured data is processed to obtain formation parameters. E.g., the gamma ray log can be used to determine the formation type using known methods, as well as formation bulk density, water density, and porosity, etc. Transition time DT is also obtained based on seismic survey data or well log data. In step 902, vertical stress or is calculated by integrating the bulk density of the formation. In step 903, the hydrostatic pore pressure can be calculated based on Equation (3) using the water density ρ_{w}, the depth D, and gravity g. In step 904, the formation compaction constant is assumed based on empirical data, e.g., based on data from the neighboring wells. In step 905, DTₙ is calculated according to Equation (5). In step 906, the pore pressure is calculated based on Equation (4). The calculated pore pressure is compared against the pore pressure measured during drilling in step 907. The difference between the calculated and measured pressures is compared with a preset threshold value in step 908. When the difference is larger than the threshold value, the formation compaction constant is adjusted in step 909 and used in recalculating DTₙ is step 905. Such iterations are carried out until the difference is lower than the threshold value.

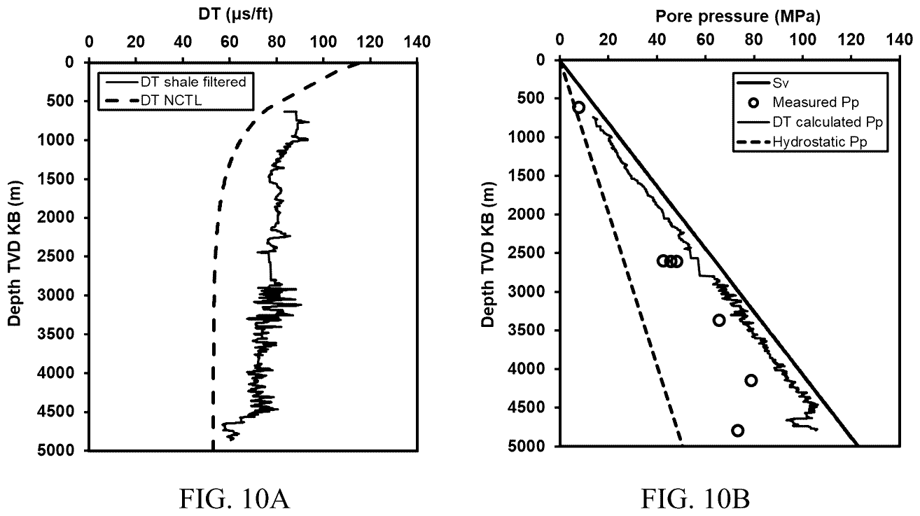

FIGS. 10A and 10B display intermediate results prior to the completion of iterations. The broken line represents DTₙ while the jagged line shows the calculated DT. They do not match, as shown in FIG. 10A. Correspondingly, in FIG. 10B, the straight line represents the vertical stress; the broken line is the hydrostatic pore pressure; the jagged line denotes the calculated pore pressure; while the circles represent measured pore pressure. It is evident that the calculated and the measured pore pressures do not match.

Nevertheless, more iterations in the method of FIG. 9 generated better results, as shown in FIG. 11A and FIG. 11B. In contrast to FIG. 10B, the calculated pore pressure and measured pore pressure in FIG. 11B match.

FIG. 12 shows a comparison of pore pressure predictions between a conventional transit time method (labelled as “pₚ old method”) and a method of current disclosure (labelled as “pₚ new method,” which is the pore pressure curve in FIG. 11B). Although the “pₚ old method” curve and the “pₚ new method” curve overlap significantly below the depth of 2500 m, the measured pore pressure (“Measured pₚ”) at about 500 m match the “pₚ new method” curve much better. As such, this comparison shows that the method of the current disclosure performs better as it predicts pore pressure values in a wider range of depth.

According to a further embodiment in this disclosure, the pore pressure prediction can be further verified. In particularly, the Eaton's equation—Equation (6)—can be used to calculate pore pressure based on the resistivity obtained from well log data:

$${p}_{r} = {σ}_{V} - ( {σ}_{V} - {p}_{n} ) {( \frac{R}{{R}_{n}} )}^{n} , \qquad ( 6 )$$

wherein n is the exponent, normally n=1.2; R is the resistivity based on the well log data; and Rn is the resistivity in the normal compaction condition (NCTL), which can be calculated using Equation (7):

$${R}_{n} = {R}_{0} {e}^{bD} , \qquad ( 7 )$$

wherein R₀ is the resistivity of the formation in the mudline or at the ground surface; and b is a constant.

Methods of the current disclosure are applicable to for different types of subsurface formation. For example, the method is applicable to a shale formation, including shale oil and shale gas formations. Based on the pore pressure pressures obtained in the shale formations from this invention, the pore pressures in other formations, such as sandstones, limestones can be accurately calculated by applying publicly available Centroid theory.

Embodiments of the present disclosure have been described in detail. Other embodiments will become apparent to those skilled in the art from consideration and practice of the present disclosure. Accordingly, it is intended that the specification and the drawings be considered as exemplary and explanatory only, with the true scope of the present disclosure being set forth in the following claims.

We claim:

1. A method for estimating formation pore pressure in a subsurface formation, comprising:
S1, deploying a plurality of data recording sensors in a survey region and/or in a well logging tool into a wellbore in the survey region;
S2, collecting seismic data and well log data using the plurality of data recording sensors;
S3, storing the seismic data and well log data in one or more memories in a computer system;
S4, processing, by the computer system, the seismic and well log data to determine formation parameters selected from a formation type, a formation bulk density, a formation porosity, a formation water density, a depth, a transit time, and a gravity;
S5, calculating, by the computer system, a vertical stress by integrating the formation bulk density in a vertical direction of the formation;
S6, calculating, by the computer system, a hydrostatic pore pressure based on the formation water density, the depth, and the gravity;
S7, calculating, by the computer system, a normal porosity based on an initial porosity or a normal transit time based on an initial transit time, a formation compaction constant, and the depth;
S8, calculating, by the computer system, a calculated pore pressure; and
S9, obtaining a difference between the calculated pore pressure with a measured pore pressure, when the difference is larger than a threshold value, adjusting the formation compaction constant to a different value, inputting the adjusted formation compaction constant into S7 and repeating S7, S8, and S9, and when the difference is not larger than the threshold value, outputting the calculated pore pressure as the formation pore pressure.

2. The method of claim 1, wherein the calculated pore pressure is obtained according to Equation 1:
$${p}_{ϕ} = {p}_{n} + \frac{( {σ}_{V} - {p}_{n} )}{cD} ln ( \frac{ϕ}{{ϕ}_{n}} ) , \qquad ( 1 )$$
wherein p_{φ} is the calculated formation pore pressure, pₙ is the hydrostatic pore pressure, or is the vertical stress, D is the depth, c is the formation compaction constant, φ is the formation porosity, and φₙ is the normal porosity.

3. The method of claim 2, wherein S4 comprises calculating the formation porosity based on the bulk formation density and/or formation neutron logs.

4. The method of claim 3, wherein S7 comprises calculating the normal porosity according to Equation 2:
$${ϕ}_{n} = {ϕ}_{0} {e}^{- cD} \qquad ( 2 )$$
wherein φ₀ is the porosity in the mudline or at the ground surface, and has a value of 0.5-0.8.

5. The method of claim 3, wherein S6 comprises calculating hydrostatic pore pressure according to Equation 3:
$${p}_{n} = {ρ}_{w} gD \qquad ( 3 )$$
wherein ρ_{w} is the formation water density and g is the acceleration of gravity.

6. The method of claim 1, wherein the calculated pore pressure is obtained according to Equation 4:
$${p}_{s} = {p}_{n} + \frac{( {σ}_{V} - {p}_{n} )}{cD} [ ln ( DT - {DT}_{m} ) - ln ( {DT}_{n} - {DT}_{m} ) ] , \qquad ( 4 )$$
wherein pₛ is the formation pore pressure, pₙ is the hydrostatic pore pressure, σ_{V} is the vertical stress, D is the depth, c is the formation compaction constant, DT is the measured transit time, DTₘ is the compressional transit time, and DTₙ is the normal transit time.

7. The method of claim 3, wherein S7 comprises calculating the normal transit time according to Equation 5:
$${DT}_{n} = {DT}_{m} + ( {DT}_{m 1} - {DT}_{m} ) {e}^{- cD} , \qquad ( 5 )$$
in which DTₘₗ is the compressional transit time in the mudline or the ground surface, D is the depth.

8. A system for determining formation pore pressure in a subsurface formation of a survey region, the system comprising:
a plurality of seismic data recording sensors positioned in the survey region at different locations and/or a well logging tool including seismic data recording sensors positioned in a well bore in the survey region;
a blasting device positioned at each point of incidence in the survey region to generate seismic waves, which travel through subsurface earth formations;
wherein the data recording sensors transmit seismic data and well log data to a computer system including one or more memories and at least one processor, the one or memories store the transmitted seismic data, the transmitted well log data, and instructions, and the one or more processors execute the instructions stored in the one or more memories to implement:
S1, processing the seismic data and/or well log data to determine formation parameters selected from a formation type, a formation bulk density, a formation porosity, a formation water density, a depth, a transit time, and a gravity;
S2, calculating a vertical stress by integrating the formation bulk density in a vertical direction of the formation;
S3, calculating a hydrostatic pore pressure based on the formation water density, the depth, and the gravity;
S4, calculating a normal porosity based on an initial porosity or a normal transit time based on an initial transit time, a formation compact constant, and the depth;
S5, calculating a pore pressure; and
S6, obtaining a difference between the calculated pore pressure with a measured pore pressure, when the difference is larger than a threshold value, inputting the formation compaction constant of a different value into S4 and repeating S4, S5, and S6, and when the difference is not larger than the threshold value, outputting the calculated pore pressure as the formation pore pressure.
